(19) United States
(12) Patent Application Publication
(10) Pub. No.: US 2026/0321739 A1
(43) Pub. Date: Oct. 15, 2026

(54) NEGATIVE ELECTRODE FOR ALL-SOLID-STATE BATTERY AND ALL-SOLID-STATE BATTERY INCLUDING SAME

(71) Applicant: SAMSUNG SDI CO., LTD., Yongin-si, Gyeonggi-do (KR)

(72) Inventors: Duk-Hyoung YOON, Yongin-si, Gyeonggi-do (KR); Dongho KOO, Yongin-si, Gyeonggi-do (KR); So-Il MOON, Yongin-si, Gyeonggi-do (KR); Sangkyu LEE, Yongin-si, Gyeonggi-do (KR)

(73) Assignee: SAMSUNG SDI CO., LTD., Yongin-si, Gyeonggi-do (KR)

(21) Appl. No.: 18/880,227

(22) PCT Filed: Apr. 4, 2024
(86) PCT No.: PCT/KR2024/004420

§ 371 Date: Dec. 30, 2024

(30) Foreign Application Priority Data
Nov. 27, 2023 (KR) 10-2023-0167095

(51) Int. Cl. H01M 10/42; H01M 4/02; H01M 4/133; H01M 4/587; H01M 4/70; H01M 10/0562

(52) U.S. Cl. CPC H01M 10/4235; H01M 4/133; H01M 4/587; H01M 4/70; H01M 10/0562; H01M 2004/021; H01M 2004/027

(57) ABSTRACT

Disclosed are a negative electrode for an all-solid-state battery and an all-solid-state battery including the same, the negative electrode for an all-solid-state battery including a current collector having a groove formed therein; a metal filled inside the groove; and a carbon layer located on one surface of the current collector to cover the groove.

### CROSS-REFERENCE TO RELATED APPLICATION

The present application is a National Stage Application of PCT International Application No. PCT/KR 2024/004420 filed on Apr. 4, 2024, which claims priority to Korean Patent Application 10-2023-0167095, filed in the Korean Intellectual Property Administration on Nov. 27, 2023, the disclosure of which is incorporated herein by reference in its entirety.

### TECHNICAL FIELD

A negative electrode for an all-solid-state battery and an all-solid-state battery including the same are disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

An all-solid-state battery among rechargeable lithium batteries refers to a battery in which all materials are solid, and in particular, a battery using a solid electrolyte.

### Technical Problem

An embodiment provides a negative electrode for an all-solid-state battery capable of effectively suppressing lithium dendrite formation.

Another embodiment provides an all-solid-state battery including the negative electrode.

### Technical Solution

An embodiment provides a negative electrode for an all-solid-state battery including a current collector having a groove formed therein; a metal filled inside the groove; and a carbon layer including a carbon-based material on one surface of the current collector so as to cover the groove.

Another embodiment provides an all-solid-state battery including a negative electrode including a current collector and a negative electrode coating layer on one surface of the current collector; a positive electrode; and a solid electrolyte layer between the negative electrode and the positive electrode, wherein the negative electrode is the aforementioned negative electrode.

The solid electrolyte may be a sulfide-based solid electrolyte.

### ADVANTAGEOUS EFFECTS

The negative electrode for an all-solid-state battery according to an embodiment may provide an all-solid-state battery capable of effectively preventing lithium dendrites during charge and discharge.

### BRIEF DESCRIPTION OF THE DRAWINGS

FIG. 1 is a drawing schematically showing the structure of a negative electrode for an all-solid-state battery according to an embodiment.

FIG. 2 is a drawing schematically showing the structure of a negative electrode for an all-solid-state battery according to another embodiment.

FIG. 3 is a schematic drawing showing the structure of a negative electrode for an all-solid-state battery according to another embodiment.

FIG. 4 is a schematic drawing showing the structure of a negative electrode for an all-solid-state battery according to another embodiment.

FIG. 5 is a schematic view schematically showing the charge/discharge state of an all-solid-state battery according to an embodiment.

FIG. 6 is a schematic view illustrating an all-solid-state battery according to another embodiment.

### DETAILED DESCRIPTION OF THE INVENTION

Hereinafter, embodiments of the present invention will be described in detail. However, these embodiments are merely examples, the present invention is not limited thereto, and the present invention is defined by the scope of claims.

The terminology used herein is used to describe embodiments only, and is not intended to limit the present disclosure. Expressions in the singular include a plurality of expressions unless the context clearly dictates otherwise.

As used herein, “combination thereof” means a mixture, a laminate, a composite, a copolymer, an alloy, a blend, a reaction product, and the like of the constituents.

The term “comprise,” “include” or “have” are intended to designate that the performed characteristics, numbers, step, constituted elements, or a combination thereof is present, but it should be understood that the possibility of presence or addition of one or more other characteristics, numbers, steps, constituted element, or a combination do not be precluded in advance.

Throughout the present specification, unless explicitly described to the contrary, the word “comprise” and variations such as “comprises” or “comprising”, will be understood to imply the inclusion of stated elements but not the exclusion of any other elements.

In addition, the terms “about,” “substantially,” and the like used throughout the present specification are used as meanings at or close to the numerical values when manufacturing and material tolerances inherent in the stated meaning are presented, and in order to facilitate the understanding of this application, exact or absolute figures are used to prevent undue exploitation by unscrupulous infringers of the disclosure.

Throughout the present specification, “A and/or B” means “A or B or both.”

As used herein, when specific definition is not otherwise provided, it will be understood that when an element such as a layer, film, region, or substrate is referred to as being “on” another element, it may be directly on the other element or intervening elements may also be present.

In the present invention, “particle size” or “particle diameter” may be an average particle size. Additionally, the average particle size may be defined as the average particle size (D50) based on 50% of the cumulative volume in the cumulative size-distribution curve. The particle size may be measured by methods widely known to those skilled in the art, for example, by using a particle size analyzer, a transmission electron microscope, a scanning electron microscope, or a field emission scanning electron microscopy (FE-SEM). Alternatively, a dynamic light-scattering measurement device is used to perform a data analysis, and the number of particles is counted for each particle size range, from this, the average partiele diameter (D50) value may be easily obtained through a calculation, and it may be measured using a laser diffraction method. It may be measured by the laser diffraction method as follows, and the particles to be measured are dispersed in a dispersion medium and then introduced into a commercially available laser diffraction particle size measuring apparatus (for example, MT 3000 of Microtrac), ultrasonic waves of about 28 kHz are irradiated with an output of about 60 W, and an average particle diameter (D50) in 50% reference of the particle size distribution in a measuring apparatus may be calculated.

“Thickness” may be measured through a photograph taken with an optical microscope such as a scanning electron microscope.

In an embodiment, the thickness may mean a size in a direction substantially perpendicular to the longitudinal direction.

A negative electrode for an all-solid-state battery according to an embodiment includes a substrate having a groove formed therein; a metal filled inside the groove; and a carbon layer on one surface of the substrate so as to cover the groove.

To explain in detail, according to an embodiment, the negative electrode has a groove formed in a substrate, a metal filled inside the groove, and a carbon layer to cover the groove,

The all-solid-state battery means a battery in which, if charged, lithium ions are deintercalated from a positive electrode active material, pass through a solid electrolyte, and move toward a negative electrode, and as a result, lithium is precipitated and deposited on a negative electrode current collector, so that a lithium-containing layer is formed between the current collector and the negative electrode coating layer. In such all-solid-state batteries, the lithium-containing layer may be referred to as a deposition-type negative electrode.

The negative electrode coating layer is generally formed as a single layer by mixing metal and amorphous carbon. In an all-solid-state battery, a considerable amount of pressure may be applied to the entire negative electrode within the battery during the pressing process in which the negative electrode, electrolyte, and positive electrode are stacked and then pressure is applied to bring closer them together. Therefore, lithium precipitation moving toward the negative electrode during charge and discharge may occur at any location on the negative electrode surface, and lithium precipitation may occur excessively at a specific location. Excessive precipitation of lithium, for example, overgrown lithium dendrites, may cause problems by penetrating the electrolyte layer and making contact with the positive electrode. Even if a separate carbon layer is formed on the negative electrode coating layer, the prevention effect may be minimal if lithium precipitation occurs excessively at a specific area of the negative electrode surface.

According to an embodiment, a negative electrode for an all-solid-state battery has metal and carbon separately present in a current collector, and in particular, a metal is located within a groove formed in the current collector, and a carbon layer is formed on one surface of the current collector while surrounding the groove.

If fabricating an all-solid-state battery including such a negative electrode, the pressure generated during the pressurizing process is greater in an area where no grooves are formed than inside the grooves, so lithium ions that move toward the negative electrode during charging and discharging are mainly precipitated and deposited on the lower part of the metal inside the grooves. Therefore, even if lithium dendrites are formed, they may form primarily inside the grooves. Accordingly, even if a large number of lithium dendrites are formed, the distance from the electrolyte may be kept far away or the distance from the electrolyte may be maintained at a constant level, so that the problem of lithium dendrites penetrating the electrolyte and coming into direct contact with the positive electrode, resulting in a short circuit, may be prevented. The effect of suppressing short circuit occurrence due to lithium dendrites may be more significantly obtained in an embodiment in which lithium precipitation and growth occur inside the grooves rather than forming a separate carbon layer on the negative electrode coating layer.

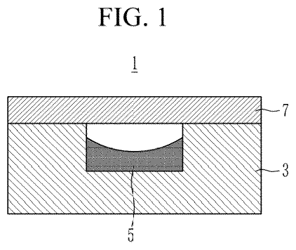

In an embodiment, the metal may completely fill the interior of the groove, or may only partially fill the interior. For example, the metal 5 may be located in the groove so as to be lower than the height of the groove in the thickness direction of the current collector 3 of the negative electrode 1, as shown in FIG. 1. A carbon layer 7 may be formed on one surface of a current collector 9 so as to cover the groove and the current collector. In this case, a void space may be located between the metal 5 and the carbon layer 7.

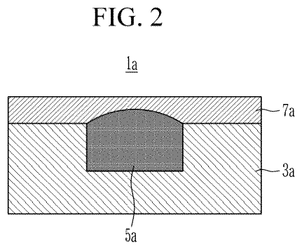

Additionally, the metal may be located convexly, completely filling the interior of the groove. For example, as shown in FIG. 2 regarding the negative electrode 1a of another embodiment, the metal 3a may be located so as to completely fill the inside of the groove formed in the current collector 3a and be located higher than the height of the groove in the thickness direction of the current collector. At this time, the carbon layer 7a may be formed to cover both the current collector 3a and the metal 5a.

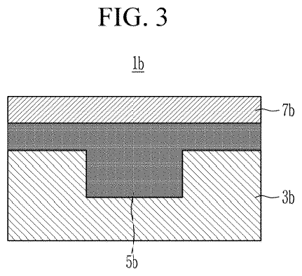

According to another embodiment, in the negative electrode 1b of FIG. 3, the metal 5b may be filled in the groove of the current collector 3b and may also be located on the surface of the current collector 3b. In this case, the metal 5b located on the surface of the current collector 3b may be located substantially flat. Additionally, a carbon layer 7b may be formed to cover the metal 5b.

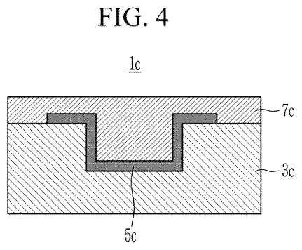

According to another embodiment, as in the negative electrode 1c shown in FIG. 4, the metal 5c may be located on the surface of the current collector 3c while being located on the lower surface and the peripheral surface of the groove, and the carbon layer 7c may be located on the surface of the current collector 3c while surrounding the metal 5c, for example, having a predetermined thickness.

Thus, as long as the metal is located within the groove formed in the current collector and is located separately from the carbon layer, it does not matter in what form it is located on the current collector.

However, it is appropriate for the metal to be located lower than the height of the groove in the thickness direction of the current collector, as this may more effectively prevent the problem of lithium dendrites penetrating the solid electrolyte and making direct contact with the positive electrode.

In an embodiment, the metal may be Ag, Au, Sn, Zn, Al, Mg, Ge, Cu, In, Ni, Bi, Pt, Pd, or a combination thereof. In an embodiment, the metal may be Ag. If the negative electrode includes the metal, it is suitable because it may improve electrical conductivity.

The metal may be a nanoparticle, and the size of the metal nanoparticle may be, for example, an average size of several tens nanometers to several hundred micrometers, and there is no need to limit it thereto.

In an embodiment, the average diameter of the groove may be less than or equal to 200 μm. may be 1 μm to 200 μm, or 10 μm to 200 μm. In an embodiment, the average diameter of the groove may be the length of the major axis, among which the horizontal and vertical lengths are measured using SEM. If the average diameter of the groove is within the above range, lithium dendrites generated during charging and discharging may be sufficiently located inside the groove. which is more appropriate.

The thickness of the groove may be less than or equal to 90%, greater than 0% and less than or equal to 90%, or 20% and 80% based on 100% of the thickness of the current collector. At this time, the thickness of the groove may mean the depth of the groove. If the thickness of the groove is within the above range, lithium dendrites generated during charging and discharging may be sufficiently located inside the groove, which is more appropriate.

The groove area may be less than or equal to 90% of the area of the current collector, and may be 10% to 90% of the area of the current collector.

If the metal is filled only partially inside the groove, the metal may be filled inside the groove in an area of less than or equal to 50%, 5% to 50% based on 100% of the interior area of the groove. If the groove inside the metal is filled with the above area %, the groove forming effect may be more appropriately obtained.

In the negative electrode according to an embodiment, the amount of the metal may be 3 wt % to 40 wt %, 3 wt % to 30 wt %, 4 wt % to 25 wt %, 5 wt % to 20 wt %, or 5 wt % to 15 wt %, based on 100 wt % of the total amount of the metal and the carbon-based material.

Additionally, the carbon-based material may be included in an amount of 60 wt % to 97 wt %, 70 wt % to 97 wt %, 75 wt %, to 96 wt %, 80 wt %, to 95 wt %, or 85 wt %, to 95 wt %, based on 100 wt % of the total amount of the metal and the carbon-based material.

The carbon-based material included in the carbon layer may include amorphous carbon or crystalline carbon. The amorphous carbon may be, for example, carbon black, acetylene black, denka black, ketjen black, furnace black, activated carbon, or a combination thereof. An example of the carbon black is Super P (Timcal). The crystalline carbon may be unspecified-shaped. plate-shaped, flake-shaped, spherical-shaped or fibrous-shaped natural graphite, artificial graphite, carbon nanotubes, graphene, or a combination thereof.

The amorphous carbon may be a single particle or may be an aggregate having a secondary particle form in which primary particles are aggregated. If the above amorphous carbon is a single particle, it may be an amorphous carbon particle having an average particle diameter of less than or equal to 100 nm, for example, a nanosize of 10 nm to 100 nm.

In addition, if the amorphous carbon is an aggregate, the particle size of the primary particle may be 20 nm to 100 nm, and the particle size of the secondary particle may be 1 μm to 20 μm.

In an embodiment, the particle size of the primary particles may be 20 nm to 90 nm, 20 nm to 80 nm, or 30 nm to 80 nm.

In an embodiment, the particle size of the secondary particles may be 1 μm to 15 μm, 2 μm to 10 μm, or 2 μm to 7 μm.

The shape of the primary particles may be spherical, elliptical, plate-shaped, and combinations thereof. In an embodiment, the shape of the primary particles may be spherical, elliptical, and a combination thereof.

The carbon layer may further include a binder.

The binder may include a non-aqueous binder, an aqueous binder, or a combination thereof.

The non-aqueous binder may include, for example, polyvinylchloride, carboxylated polyvinylchloride, polyvinyl fluoride, polyethylene oxide, an ethylene propylene copolymer, polystyrene, polyvinylpyrrolidone, polyurethane, polytetrafluoroethylene, polyvinylidene fluoride, polyethylene, polypropylene, polyamideimide, polyimide, polyacrylate, or a combination thereof.

The aqueous binder may include a styrene-butadiene rubber, an acrylated styrene-butadiene rubber, an acrylonitrile-butadiene rubber, polyvinyl alcohol, polyethylene oxide, polyvinyl pyrrolidone, polyepichlorohydrin, polyphosphazene, polyacrylonitrile, ethylenepropylenediene copolymer, polyvinylpyridine, chlorosulfonated polyethylene, latex, a polyester resin, an acrylic resin, a phenol resin, an epoxy resin, an acrylic rubber, a butyl rubber, a fluorine rubber, or a combination thereof.

The negative electrode binder may include a cellulose-based compound. Additionally, the negative electrode binder may include both the aqueous binder and a cellulose-based compound. The cellulose-based compound may include carboxymethyl cellulose, hydroxypropylmethyl cellulose, methyl cellulose, alkali metal salts thereof, or a combination thereof. The alkali metal may be Na, K, or Li. The cellulose-based compound may also act as a thickener capable of imparting viscosity in addition to being a binder.

The binder is not limited thereto, and any binder used in the relevant technical field may be used, and the amount of the binder may also be appropriately adjusted.

The binder may be included in an amount of 1 wt % to 40 wt % based on 100 wt % of the total carbon layer. The binder may be included in an amount of 1 wt % to 15 wt % based on 100 wt % of the total carbon layer, for example, the binder may be included in an amount of 1 wt % to 14 wt %, 1 wt % to 10 wt %, 1 wt % to 8 wt % or 1 wt % to 5 wt % based on 100 wt % of the total carbon layer.

If the above binder is included in the carbon layer of the all-solid-state battery in the above amount range, the electrical resistance and adhesive strength may be improved, thereby improving the characteristics (battery capacity and output characteristics) of the all-solid-state battery.

The carbon layer may further include additives such as a filler, a dispersant, or an ion conductive material. The filler, dispersant, ion conductive material, etc. that may be included in the carbon layer may be known materials generally used in all-solid-state batteries.

A thickness of the carbon layer may be 1 μm to 100 μm.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet. A thickness of the negative electrode current collector may be 1 μm to 20 μm, 5 μm to 15 μm, or 7 μm to 10 μm.

The current collector may include a metal as a substrate and may further include a thin film formed on the substrate. The thin film may include an element that may form an alloy with lithium, and may be, for example, gold, silver, zinc, tin, indium, silicon, aluminum, bismuth, or a combination thereof, but is not limited thereto, and in the technical field, any element that may form an alloy with lithium may be used. If the current collector further includes the thin film and the lithium-containing layer is formed by precipitating during charging, a more flattened lithium-containing layer may be formed, thereby further improving the cycle-life of the all-solid-state battery. A thickness of the thin film may be 1 nm to 800 nm, 10 nm to 700 nm, 50 nm to 600 nm, or 100 nm to 500 nm. If the film thickness is within the above range, the cycle-life characteristics may be further improved.

A negative electrode according to an embodiment may be manufactured by the following manufacturing process.

A metal is deposited on a current collector in which a groove is formed, so that the metal is located inside the groove. The method for forming a groove in the current collector may be performed by any method capable of forming a groove, such as chemical etching or a physical method. The deposition process may be chemical vapor deposition, physical vapor deposition, or a combination thereof. The deposition process may be performed so that the metal is located lower than the height of the groove, as in FIG. 1, or it may be performed so that the metal is located convexly, completely filling the inside of the groove, as in FIG. 2.

Next, a carbon layer is formed on the obtained product. The carbon layer forming process may be formed by applying and drying a carbon layer composition including a carbon-based material, a binder, and a solvent to the product. The binder is as described above, and the solvent may be an organic solvent such as N-methyl pyrrolidone if a non-aqueous binder is used as the binder, and water may be used if an aqueous binder is used as the binder. If the metal is formed lower than the height of the groove, a structure like FIG. 1 may be formed in which a portion of the inside of the groove is not filled with the carbon layer if the carbon layer is formed.

According to an embodiment, the negative electrode may further include a lithium-containing layer between the current collector and the negative electrode coating layer.

Because the lithium-containing layer is a metal layer including lithium, it may act as a lithium reservoir.

The lithium-containing layer may be a lithium deposition layer in which lithium ions deintercalated from the positive electrode active material during charging move toward the negative electrode and are precipitated on the surface of the current collector. In this case, the lithium-containing layer may be referred to as a lithium deposition layer.

The lithium-containing layer may be a layer including lithium or a lithium alloy.

The lithium alloy includes lithium and may also include a metal capable of being alloyed with lithium. The metal capable of being alloyed with the lithium may be Ag, Au, Mg, In, Si, Sn, Al, Ge, Pb, Bi, Sb, a Si-Y alloy (wherein Y is an alkali metal, an alkaline earth metal, a Group 13 element, a Group 14 element, a transition metal, a rare earth element, or a combination thereof, but not Si), a Sn-Y alloy (wherein Y is an alkali metal, an alkaline earth metal, a Group 13 element, a Group 14 element, a transition metal, a rare earth element or a combination thereof, but not Sn). etc. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

A thickness of the lithium-containing layer may be 1 μm to 1000 μm, 1 μm to 500 μm, 1 μm to 200 μm, 1 μm to 150 μm, 1 μm to 100 μm, or 1 μm to 50 μm. If the thickness of the lithium-containing layer is within the above range, it may properly function as a lithium reservoir and may further improve its cycle-life.

If the lithium-containing layer is a lithium deposition layer, this lithium deposition layer may be formed if lithium ions are deintercalated from the positive electrode active material during charging after the all-solid-state battery is manufactured, pass through the solid electrolyte, and move toward the negative electrode, resulting in lithium precipitation and deposition on the negative electrode current collector.

The charging process may be a formation process performed 1 to 3 times at 0.05 C. to 1 C. at about 25 ° C. to 50 ° C. Because lithium included in the lithium-containing layer is ionized and moves toward the positive electrode during discharge, this lithium may be used as a negative electrode active material.

In an embodiment, because the lithium-containing layer is present between the current collector and the negative electrode active material layer, the negative electrode coating layer may serve as a protective layer for the lithium-containing layer, thereby suppressing the precipitation growth of lithium dendrites. As a result, short circuiting and capacity reduction of the all-solid-state battery may be suppressed, and as a result, the cycle-life of the all-solid-state battery may be improved.

Another embodiment provides an all-solid-state battery including the negative electrode, a solid electrolyte layer, and a positive electrode.

The solid electrolyte in the solid electrolyte layer may be an inorganic solid electrolyte such as a sulfide-based solid electrolyte, an oxide-based solid electrolyte, or a halide-based solid electrolyte, or a solid polymer electrolyte. In an embodiment, the solid electrolyte may be a sulfide-based solid electrolyte, for example an argyrodite-type sulfide-based solid electrolyte. The sulfide-based solid electrolyte is suitable because it has superior ionic conductivity compared to other solid electrolytes such as oxide-based solid electrolytes, and may exhibit excellent cycle-life characteristics over a wider operating range.

The sulfide-based solid electrolyte may be, for example Li₂S-P₂S₅, Li₂S-P₂S₅-LiX (X is a halogen element), Li₂S-P₂S₅-Li₂O, Li₂S-P2S₅-Li₂O-Lil, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂P₂S₅-LiI, Li₂S-B₂S₃, Li₂S-P₂S5-ZₘSₐ (wherein m and n are integers of 0 or more and 12 or less and Z is one of Ge, Zn, or Ga), Li₂S-GeS₂, Li₂S-SiS-Li₃PO₄, Li₂S-SiS₂LiₚMO_{q} (wherein p and q are each 0 or more and 12 or less and M is one of P, Si, Ge, B, Al, Ga, or In), LiₐM_{b}P_{c}S_{d}A_{c} (wherein a, b, c, d, and e are each 0 or more and 12 or less, but a, b, c, d, and e are not all 0, and M is Ge, Sn, Si, or a combination thereof, and A is one of F, Cl, Br, or I). For example, it may be, for example, Li₇₋ₓPS₆₋ₓF₆ (0≤x≤2), Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). In addition, specifically, it may be Li₃PS₄, Li₃PS₄, Li₇P₃S₁₁, Li₇PS₆, Li₆PS₅Cl, Li₆PS₅Cl, Li₆PS₅Br, Li₆PS₅I, Li_{5.8}PS4.8Cl_{1.2}, Li_{6.2}PS_{5.2}Br_{0.8}, and the like.

The sulfide-based solid electrolyte may be obtained by, for example, mixing Li₂S and P₂S₅ in a mole ratio of 50:50 to 90:10 or 50:50 to 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto. Mechanical milling or a solution method may be applied as a mixing method. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. Additionally, additional firing may be performed after mixing. If additional firing is performed, the crystals of the solid electrolyte may become more solid.

The sulfide-based solid electrolyte may be amorphous or crystalline, or may be a mixture of the two. Of course, a commercially available solid electrolyte may be used as the sulfide-based solid electrolyte.

The oxide-based inorganic solid electrolyte may be, for example, Li₁₊ₓTi₂₋ₓAl(PO₄)₃(LTAP) (0≤x≤4), Li_{1+x+y}AlₓTi₂₋ₓSi_{y}P_{3-y}O₁₂(0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0x≤1, 0≤y≤1), lithium lanthanum titanate (LiₓLa_{y}TiO_{3, 0}<x<2, 0<y<3), Li₂O, LiAlO₂, Li₂O-Al₂O₃-SiO₂-P₂O₅-TiO₂-GeO₂-based ceramics, Garnet-based ceramics Li₃₊ₓLa₃M₂O₁₂ M=Te, Nb, or Zr, and x is an integer of 1 to 10), or a mixture thereof.

The halide-based solid electrolyte may include a Li element, an M element (M is a metal other than Li), and an X element (X is a halogen). Examples of X may include F, Cl, Br, and I. In particular, in the halide-based solid electrolyte, at least one of Br and Cl is suitable as the above X. In addition, examples of M may include metal elements such as Sc, Y, B, AL, Ga, and In.

A composition of the halide-based solid electrolyte is not particularly limited, but may be represented by Li₆₋₃ₐMₐBr_{b}Cl_{c} (where M is a metal other than Li, 0<a<2, 0≤b≤6, 0≤c≤6, and b+c=6). At this time, a may be 0.75 or more, 1 or more, and a may be 1.5 or less. The b may be 1 or more, and may be 2 or more. Additionally, c may be 3 or more, and may be 4 or more. Specific examples of the halide-based solid electrolyte may be Li₃YBr₆, or Li₃YBr₂Cl₄.

The solid polymer electrolyte may include, for example, one or more selected from polyethylene oxide, poly(diallyldimethylammonium) trifluoromethanesulfonylimide (poly(diallyldimethylammonium)TFSI), Cu₃N, Li₃N, LiPON, Li₃PO₄-Li₂S-SiS₂, Li₂S-GeS₂-Ga₂S₃, Li₂O-11Al₂O₃, Na₂O-11Al₂O₃, (Na, Li)₁₊ₓTi₂₋ₓAlₓ(PO₄)₃ (0.1≤x≤0.9), Li₁₊ₓHf₂₋ₓAlₓ(PO₄)_{3 (}0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-silicates, Li_{0.3}La_{0.5}TiO₃, Na₅MSi₄O₁₂ (wherein M is a rare earth element of Nd, Gd, Dy, and the like), Li₅ZrP₃O₁₂, Li₅TiP₃O₁₂, Li₄Fe₂P₃O₁₂, Li₄NbP₃O₁₂, Li₁₊ₓ(M, Al, Ga)ₓ(Ge_{1-y}Ti_{y})2-x(PO₄)₃ (0≤x≤0.8, 0≤y≤1.0, and M is Nd, Sm, Eu, Gd, Tb, Dy, Ho, Er, Tm, or Yb), Li_{1+x+y}QₓTi₂₋ₓSi_{y}P_{3-y}O₁₂ (0≤x≤0.4, 0<y≤0.6, and Q is Al or Ga), Li₆BaLa₂Ta₂O₁₂, Li₇La₃Zr₂O₁₂, Li₅La₃Nb₂O₁₂, Li₅La₃M₂O₁₂ (M is Nb or Ta), and Li₇₊ₓAₓLa₃₋ₓZr₂O₁₂ (0<x<3, and A is Zn).

The solid electrolyte may in the form of particles, and an average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm.

The solid electrolyte layer may further include a binder, At this time, the binder may be a styrene butadiene rubber, polytetrafluoroethylene, polyvinylidene fluoride, polyethylene, an acrylate-based polymer, or a combination thereof, but is not limited thereto, and anything used as a binder in the art may be used. The acrylate-based polymer may be butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer is well known in the art, and thus a detailed description thereof will be omitted.

The positive electrode includes a positive electrode current collector and a positive electrode active material layer on one surface of the positive electrode current collector.

The positive electrode active material layer may include a positive electrode active material. The positive electrode active material may be a positive electrode active material capable of reversibly intercalating and deintercalating lithium ions and for example, the positive electrode active material may be, for example, at least one of a composite oxide of lithium and a metal selected from cobalt, manganese, nickel, and a combination thereof. Examples of the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.905≤a≤1.8, 0≤b≤0.5≤c≤05); LiₐNi_{1-b-c}Co_{b}B¹_{c}D¹_{α}(0.90≤a≤1.8, 0≤b≤0.5, 0≤c≤0.5, 0<α≤2); LiₐNi_{1-b-c}Co_{b}B¹_{c}O₂₋₆₀F¹_{α(}0.90≤a≤1.8, 0≤b≤0.5, 0≤c≤0.5, 0<α<2); LiₐNi_{1-b-c}Co_{b}B¹_{c}O_{2-αF}¹₂ (0.90≤a≤1.8, 0≤b≤0.5, 0≤c≤0.5, 0<α<2); LiₐNi_{1-b-c}Mn_{b}B¹D¹_{α}, (0.90≤a≤1.8, 0≤b≤0.5, 0≤c≤0.5, 0≤α≤2); LiₐNi_{1-b-c}Mn_{b}B¹_{c}O_{2-α}Fⁱ_{α(}0.90≤a≤1.8, 0≤b≤0.5, 0≤c≤0.5, 0<α<2); LiₐNi_{1-b-c}Mn_{b}B¹_{c}O_{2-αF}^{I}₂(0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}G_{c}G_{c}O₂ (0.90≤a≤1.8, 0≤b≤0.9, 0≤c≤0.5, 0≤d≤0.5, 0.001≤e≤0.1); LiₐNiₐG_{b}O₂ (0.90≤a≤1.8, 0.001≤b≤30.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₃; V₂O₅; LiV₂O₅; LiI¹O₂; LiNiVO₄; Li_{3-f)}J₂(PO4)₃(0≤f≤2); Li_{(3-f)}Fe₂(PO₄)₃(0≤f≤2); or LifePO₄.

In the above chemical formulas, A is Ni, Co, Mn, or a combination thereof; B¹ is Al, Ni, Co, Mn, Cr, Fe, Mg, Sr, V, a rare earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; I¹ is Cr, V, Fe, Se, Y, or a combination thereof; and J is V, Cr, Mn, Co, Ni, Cu, or a combination thereof.

According to an embodiment, the positive electrode active material may be a ternary lithium transition metal such as LiNiₓCo_{y}Al₂ (NCA), LiNiₓCo_{y}Mn₂O₂ (NCM) (wherein 0<x<1, 0<y<1, 0<z<1, x+y+z=1).

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail because it is well-known in the related field.

In addition, as the coating layer, any known coating layer for the positive electrode active material of an all-solid-state battery may be applied, examples of which include Li₂O-ZrO₂ (LZO). In addition, if the positive electrode active material includes nickel, cobalt and manganese, or nickel, cobalt and aluminum, the capacity density of the all-solid-state battery may be further improved and metal elution from the positive electrode active material in the charged state may be further reduced. Because of this, the long-term reliability and cycle characteristics of the all-solid-state battery may be further improved in a charged state.

Here, examples of the shape of the positive electrode active material include particle shapes such as spheres and ellipsoids. Additionally, the average particle diameter of the positive electrode active material is not particularly limited, and may be within a range applicable to the positive electrode active material of existing all-solid-state rechargeable batteries. Additionally, the amount of the positive electrode active material in the positive electrode active material layer is not particularly limited, and may be within a range applicable to the positive electrode layer of an existing all-solid-state rechargeable batteries.

The positive electrode active material layer may additionally include a solid electrolyte. The solid electrolyte included in the positive electrode layer may be the aforementioned solid electrolyte, and in this case, it may be the same as or different from the solid electrolyte included in the solid electrolyte layer. The solid electrolyte may be included in an amount of 10 wt % to 30 wt % based on a total weight of the positive electrode active material layer.

The positive electrode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

In addition, in the positive electrode active material layer, in addition to the aforementioned positive electrode active material and solid electrolyte, additives such as a conductive agent, a binder, a filler, a dispersant, and an ion conductive material may be appropriately mixed.

As the filler, dispersant, ion conductive material that may be included in the positive electrode active material layer, the same additives as those included in the negative electrode active material layer described above may be used. At this time, the conductive material may be included in an amount of 1 wt % to 10 wt % based on the total weight of the positive electrode active material layer.

Examples of the binder that may be included in the positive electrode active material layer include styrene butadiene rubber (SBR), polytetrafluoroethylene, polyvinylidene fluoride, and polyethylene.

A thickness of the above positive electrode active material layer may be 90 μm to 200 μm. For example, the thickness of the positive electrode active material layer may be 90 μm to 190 μm, 110 μm to 190 μm, or 120 μm to 180 μm. As described above, because the thickness of the positive electrode active material layer is thicker than that of the negative electrode active material layer, the capacity of the positive electrode is greater than that of the negative electrode.

The positive electrode may be manufactured by forming a positive electrode active material layer on a positive electrode current collector by dry or wet coating.

In an embodiment, a cushioning material may be additionally included to buffer thickness changes that occur if the all-solid-state battery is charged and discharged. The cushioning material may be present between the negative electrode and the case, and in the case of a battery in which one or more electrode assemblies are stacked, it may be present between different electrode assemblies.

The cushioning material may include a material having an elastic recovery rate of 50% or more and an insulating function, and specifically, may include a silicone rubber, an acrylic rubber, a fluorine rubber, nylon, a synthetic rubber, or a combination thereof. The cushioning material may exist in the form of a polymer sheet.

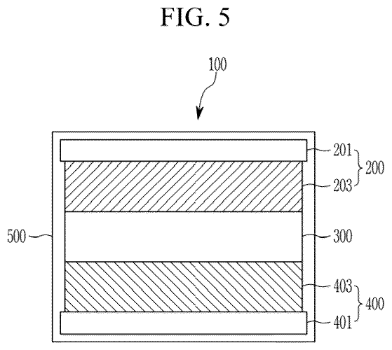

FIG. 5 is a cross-sectional view of an all-solid-state battery according to an embodiment. Referring to FIG. 5, the all-solid-state battery 100 includes an electrode assembly in which a negative electrode 400 including a negative electrode current collector 401 and a negative electrode coating layer 403, a solid electrolyte layer 300, and a positive electrode 200 including a positive electrode active material layer 203 and the positive electrode current collector 201 are stacked and a case such as a pouch housing the electrode assembly. The all-solid-state battery 100 may further include an elastic layer 500 on the outside of at least one of the positive electrode 200 and the negative electrode 400. Although FIG. 5 shows one electrode assembly including the negative electrode 400, the solid electrolyte layer 300, and the positive electrode 200, an all-solid-state battery may also be manufactured by stacking two or more electrode assemblies.

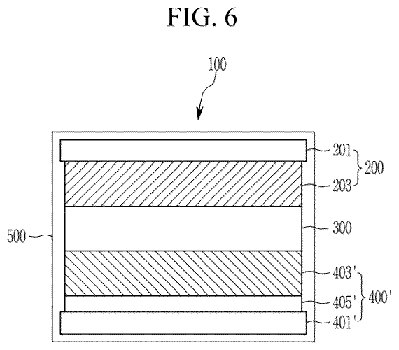

FIG. 6 schematically illustrates the structure of an all-solid-state battery according to another embodiment. This could be, for example, an all-solid-state battery in a charged state. An all-solid-state battery 100 includes a positive electrode 200 including a positive electrode current collector 201 and a positive electrode active material layer 203, a negative electrode 400′ including a negative electrode current collector 401′, a negative electrode coating layer 403′, and a solid electrolyte layer 300 between the positive electrode 200 and the negative electrode 400′, and a battery case 500 in which these are accommodated.

An all-solid-state battery according to an embodiment may be fabricated by placing a negative electrode, a positive electrode, and a solid electrolyte layer between the negative electrode and the positive electrode, preparing a stack, and pressing the stack.

The pressing process may be performed in the range of 25 °C. to 90 °C. Additionally, the pressing process may be performed by pressing at a pressure of less than or equal to 550 MPa, for example less than or equal to 500 MPa, for example 1 MPa to 500 MPa. The pressing time may vary depending on temperature and pressure, and may be, for example, less than 30 minutes, The pressing process may be, for example, an isostatic press, a roll press, a plate press, or a warm isostatic press.

### MODE FOR PERFORMING THE INVENTION

Hereinafter, examples of the present invention and comparative examples are described. These examples, however, are not in any sense to be interpreted as limiting the scope of the invention.

### Example 1

### (1) Manufacturing of Negative Electrode

A groove with an average diameter of 200 μm was formed on a stainless steel foil current collector using a physical method with a thickness (depth) of 50% of the current collector thickness of 100%. An Ag layer was deposited on a stainless steel foil current collector with a groove formed using a chemical vapor deposition method to form a metal layer with Ag deposited entirely inside the groove.

Subsequently, 96 wt % of carbon black having a specific surface area of 55m²/g and an average size of 35 nm, 2 wt % of carboxylmethyl cellulose, and 4 wt % of a styrene-butadiene rubber were mixed in water to prepare a carbon layer slurry.

After coating the carbon layer slurry on a stainless steel foil current collector having a metal layer formed thereon, vacuum drying was performed at 80 ° C. to manufacture a negative electrode including a metal layer and a carbon layer on a stainless steel foil current collector having a groove formed thereon.

### (2) Manufacturing of Solid Electrolyte Layer

an isobutyryl isobutyrate binder solution (a solid content: 50 wt %) in which an acrylate-based polymer of butyl acrylate was added to an argyrodite-type solid electrolyte of Li₆PS₅Cl, and then, mixed. Here, the solid electrolyte and the binder were mixed in a weight ratio of 98.7:1.3.

The mixing process was performed by using a Thinky mixer. Subsequently, 2 mm zirconia balls were added to the obtained mixture and then, stirred again by using a Thinky mixer to prepare slurry. The slurry was cast on a polytetrafluoroethylene release film and then, dried at room temperature to manufacture a 100 μm-thick solid electrolyte layer.

### (3) Manufacturing of Positive Electrode

A mixture was prepared by mixing 17.6 parts by weight of argyrodite-type solid electrolyte Li₆PS₅Cl, 3.53 parts by weight of conductive material CNF (Carbon Nano Fiber), and 1.76 parts by weight of binder polytetrafluoroethylene (PTFE) based on 100 parts by weight of LZO (Li-doped zinc oxide) coated positive electrode active material (LiNi_{0.9}Mn_{0.05}Co_{0.05}O₂). In the above mixture, a weight ratio of the positive electrode active material solid electrolyte, the conductive material, and the binder was 85:15:3:1.5.

The prepared mixture was coated on an aluminum foil current collector and then vacuum-dried at 45 °C. to manufacture a negative electrode including a 160 μm-thick negative electrode coating layer and a 10 μm-thick current collector.

(4) Manufacturing of All-solid-state Full-cell

The manufactured negative electrode, the solid electrolyte layer, and the positive electrode were sequentially stacked, and a pressure of 500 MPa was applied to manufacture a full-cell.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A negative electrode for an all-solid-state battery, comprising
a current collector having a groove formed therein;
a metal filled inside the groove; and
a carbon layer located on one surface of the current collector to cover the groove.

2. The negative electrode for an all-solid-state battery as claimed in claim 1, wherein the metal is located in the groove so as to be lower than a height of the groove in a thickness direction of the current collector.

3. The negative electrode for an all-solid-state battery as claimed in claim 1, wherein the metal is filled in the groove of the current collector and located on the surface of the current collector.

4. The negative electrode for an all-solid-state battery as claimed in claim 1, wherein the metal is filled in the groove of the current collector so as to be located higher than the height of the groove in a thickness direction of the current collector.

5. The negative electrode for an all-solid-state battery as claimed in claim 1, wherein the metal is located on the lower surface and the peripheral surface of the groove and on the surface of the current collector.

6. The negative electrode for an all-solid-state battery as claimed in claim 1, wherein the metal is Ag, Au, Sn, Zn, Al, Mg, Ge, Cu, In, Ni, Bi, Pt, Pd, or a combination thereof.

7. The negative electrode for an all-solid-state battery as claimed in claim 1, wherein the metal is Ag.

8. The negative electrode for an all-solid-state battery as claimed in claim 1, wherein a diameter of the groove is less than or equal to 200 μm.

9. The negative electrode for an all-solid-state battery as claimed in claim 1, wherein a thickness of the groove is less than or equal to 90% based on 100% of the thickness of the current collector.

10. The negative electrode for an all-solid-state battery as claimed in claim 1, wherein the metal is filled inside the groove to an area of less than or equal to 50% based on 100% of the inside area of the groove.

11. The negative electrode for an all-solid-state battery as claimed in claim 1, wherein the carbon layer includes amorphous carbon.

12. An all-solid-state battery, comprising
the negative electrode as claimed in claim 1;
a positive electrode; and
a solid electrolyte layer between the negative electrode and the positive electrode.

13. The all-solid-state battery as claimed in claim 12, wherein the solid electrolyte is a sulfide-based solid electrolyte.
